(19) United States
(12) Patent Application Publication
(10) Pub. No.: US 2022/0121788 A1
(43) Pub. Date: Apr. 21, 2022

(54) VOLUME MODEL GENERATION FOR MULTICOMPONENT OBJECTS

(71) Applicant: SEW-EURODRIVE GMBH & CO. KG, Bruchsal (DE)

(72) Inventors: Horst Christian ANDREE, Pforzheim (DE); Andreas REUCK, Pforzheim (DE)

(73) Assignee: SEW-EURODRIVE GMBH & CO. KG, Bruchsal (DE)

(21) Appl. No.: 17/424,010

(22) PCT Filed: Dec. 9, 2019
(86) PCT No.: PCT/EP2019/025440

§ 371 Date: Jul. 19, 2021

(30) Foreign Application Priority Data
Jan. 18, 2019 (DE) 10 2019 000 313.6

(51) Int. Cl. G06F 30/17; G06F 30/20

(52) U.S. Cl. CPC G06F 30/17; G06F 2111/20; G06F 30/20

(57) ABSTRACT

A method for providing a volume model for a mechanical object includes: receiving configuration parameters, indicating the components of the object and/or the type of component, for the object; generating a construction model for the object from the component construction models of the components as a function of the configuration parameters, a component construction model for each component being stored in a data collection, and a component construction model defining at least one outer surface of the component; generating the volume model for the object from component volume models of the components, the component volume models being superimposed onto one another and outer surfaces of component volume models that are included in an interior space of another component volume model and/or that abut outer surfaces of another component volume model being removed.

### FIELD OF THE INVENTION

The present invention relates to automated or semi-automated production. More specifically, the present invention relates to a method, a computer program, a computer-readable medium, and to a system for providing a volume model for a mechanical object which is made up of multiple components.

### BACKGROUND INFORMATION

Electromechanical objects such as geared motors are offered in a great number of configuration variants, which, for instance, may pertain to the provided rotational speed, the transmission ratio, flange types, flange shapes, torques, design lengths, gear unit variants, motor variants and housing variants. A variant number of more than 109 is not rare.

Generally, a certain configuration variant can be ordered online, whereupon a volume model of the corresponding object is then made available on the basis of which the possible installation of the object in a technical system is able to be checked with the aid of its construction model. Normally, the volume model is produced manually because the cavities projecting into the object are unable to be distinguished from an interior space of the object, which should be filled in a volume model.

The manual production of the volume model is time-consuming and prone to errors.

### SUMMARY

Example embodiments of the present invention provide volume models for configurable objects in a manner that is rapid and low in errors.

According to an example embodiment of the present invention, a method provides a volume model for a mechanical object and/or a component which is made up of multiple components. The method is automatically carried out by a computer system which optionally has a plurality of computers. A mechanical object includes one or more solids.

Hereinafter, a distinction is made between, for instance, a three-dimensional volume model and a three-dimensional construction model. The object has a volume model while its components have a component volume model in each case. In the same manner, the object has a construction model while its components have a component construction model in each case. Whereas both models encompass data about three-dimensional characteristics of the object, a volume model relates only to the outer shape of an object and optionally includes physical parameters that pertain to an interaction of the object with its environment. In contrast thereto, a construction model additionally includes data pertaining to the properties of the object with regard to its inner components. If a ‘model’ is mentioned in the following text, then this means both a volume model and a construction model.

The object is a mechanical and in particular an electromechanical object such as an electric motor or a geared motor. As components, for example, the object has a housing, a gear unit, an electrical drive as well as their components.

According to example embodiments, the method includes receiving configuration parameters for the object, the configuration parameters indicating the components that make up the object and/or the type of the respective component. The configuration parameters indicate the structure of the object. Among these are parameters such as existing and non-existent components and variants of components of the object. More specifically, the configuration parameters include the lengths and/or types of housing components of the object.

In general, the components of the object are the parts that make up the object. For instance, the components include housing parts, shafts, flanges, bearings, gear wheels, electrical coils and/or magnets.

According to example embodiments, the method includes generating a construction model for the object from component construction models of the components as a function of the configuration parameters, a component construction model for each component being stored in a data collection, and a component construction model defining at least an outer surface of the component. It is possible that the construction model for the object is produced with the aid of the configuration parameters by loading for each component a basic construction model from the data collection stored for the respective component in the data collection.

According to example embodiments, the method furthermore includes generating the volume model for the object from component volume models of the components, the component volume models being superimposed onto one another and outer surfaces of component volume models that are included in an interior space of another component volume model and/or that abut outer surfaces of another component volume model are removed.

Also stored in the data collection is the manner in which the components and/or the associated models, i.e., the component construction models and/or the component volume models, are spatially assembled such as by translations and/or rotations relative to one another, so that the object and/or the overall model is/are obtained. With the aid of these data, the component volume models are combined and/or superimposed into a model. The result is a superimposed model in which surfaces of a component are included in the interior space of another component. These surfaces or parts of these surfaces are then removed so that a volume model of the object is created which has a single interior space and surfaces that define this interior space.

Since the volume model defines only the outer edges and outer surfaces of the object but no inner structure, the memory requirement of the volume model is smaller than that of the construction model. In this manner, the volume model is transmitted more rapidly via a data communications network. In addition, it requires less memory space in a construction model of a technical system in which it is embedded.

According to example embodiments, component volume models are generated from the component construction models by filling an interior space of the respective component construction model. For instance, a component volume model is generated from a component construction model in that it is virtually completely filled inside so that it corresponds to a solid body. It is possible that a component volume model has only the outer surfaces of a component and/or of the associated component construction model. The outer surfaces of a component volume model of a component correspond to the outer surfaces of the component construction model of the component.

According to example embodiments, component volume models are generated from basic component volume models as a function of the configuration parameters, and each basic component volume model is stored in the data collection together with a component construction model for the component.

Basic component volume models and basic component construction models are stored in the data collection, e.g., a plurality of data files which are stored in a computer, or a database. For each component, a component construction model, a basic component construction model, and/or a basic component volume model is/are provided. These models are stored in the data collection, for instance, by a design engineer.

The basic models are used as the starting point for generating the concrete models from the configuration parameters. Using a housing length as a configuration parameter, for example, the length of the housing in the corresponding basic model is scaled in order to obtain the concrete model. The manner in which the basic model has to be modified based on the configuration parameters in order to generate the respective concrete model is stored in the basic models.

A component volume model and/or basic component volume model is/are defined by a plurality of surfaces that enclose an interior space of the component. For example, the surfaces are defined via points that define their corners, and/or via a wire frame. The surfaces separate the interior space from an environment of the components. In this context, a volume model is distinguished from a construction model because the interior space is defined in a volume model whereas this is not the case for a construction model which includes cavities in the interior.

It is possible that a portion of the component volume models is generated from the construction models and another portion of the component volume models is generated from basic component volume models.

According to example embodiments, the method furthermore includes embedding the volume model in a system construction model of a technical system which includes the object. For example, numerous objects of the same shape are installed in a technical system. In the volume model, these objects are considered in the planning of the construction model of the technical system so that the processing of the construction model does not cause any problems.

According to example embodiments, the method also includes a collision check of the volume model with other construction models of the technical system in order to ascertain a correct installation of the object. With the aid of a collision check, it is ascertained whether the space of the object overlaps with a space of another component of the technical system.

Generally, only the outer shape of the object is required for a collision check. This makes it possible to check whether the object is installable in the technical system in the desired configuration and/or whether sufficient space is available. Thus, it is possible that a party ordering the object carries out a collision check in connection with the system in which the object is to be installed and initiates an order of the object only following this check.

According to example embodiments, the volume module is generated in a first computer and transmitted to a second computer. Because of the reduced memory requirement, it is possible to transmit a greater number of volume models via a data communications network such as the Internet. The collision check is carried out in the second computer, for instance.

According to example embodiments, physical parameters are allocated to every component volume model. These physical parameters are also allocated to the volume model of the object. For example, this allocation is performed via aggregation rules that are stored in the data collection. The weight of the components is summed up to the weight of the object, for example.

According to example embodiments, the physical parameters include material parameters. The material parameters include a material type, a material, a thermal conductivity, and/or a weight. During the aggregation, a rule specifies for different material types of components which components overwrite the material type of another component if the volumes of the components overlap. The same applies to the thermal conductivity, for example. In the case of an object having different material parameters, a volume model having intermediate surfaces is generated which separates regions of different material parameters.

According to example embodiments, the physical parameters include mechanical parameters. The mechanical parameters, for instance, include a rotatability about an axle and/or a movability in a space region and/or along an axle. For instance, a shaft of the object is denoted in the volume model as being rotatable. In an object featuring different mechanical parameters, a volume model featuring intermediate surfaces is generated which separates regions having different mechanical parameters.

According to example embodiments, the method furthermore includes a simulation of the object in a construction model of a technical system based on the physical parameters. It is checked, for instance, whether the space traversed by movable parts collides with other objects of the technical system. In addition, it is checked which materials of what objects come into contact with one another, for instance, in order to exclude contact between hot objects and plastic materials. The simulation is carried out in the aforementioned second computer, for example.

According to example embodiments, a component volume model has a depression, a cavity and/or a concave region. If a volume model is created from a construction model in which merely an outer shape of the construction model is determined, then it is possible that holes will be covered which project into the object and into which screws, shafts, etc., are inserted, for example. For this reason, component volume models are additionally provided, which are adapted, for instance, by the design engineer of the construction model. It is furthermore not necessary to adapt a component volume model and/or a basic component volume model if only the interior space of the construction model changes.

According to example embodiments, the method also includes a production of the object based on the construction model of the object. The construction model is transmitted to a production facility for the actual production of the object.

According to example embodiments, the object includes housing components, inner components and/or mixed components. Based on these types of components, it is decided for which component a volume model is to be generated and/or which aggregation rules are to be applied to the assembly of the volume model for the object.

A housing component is a component which includes a portion of a housing of the object and/or to which a volume model is then allocated for the outer surfaces of the housing.

An inner component is a component which is entirely situated in the interior of a housing component and/or to which no volume model is allocated. Examples of inner components are gear wheels and electrical components of an electric motor.

A mixed component is a component which is situated both in the interior of and outside a housing component. For instance, aggregation rules exist for such components according to which the part of the component that is situated in the interior space is cut off in the aggregation. One example of a mixed component is a shaft.

Further aspects relate to a computer program that, when executed on at least one processor, is adapted to carry out the method as described herein, and to a computer-readable medium on which a corresponding computer program is stored. The computer program is executed by a plurality of computers, for instance. A computer-readable medium, for example, is a hard disk, a USB memory device, a RAM, a ROM, an EPROM or a FLASH memory. For instance, a computer-readable memory is also a data communications network such as the Internet, that allows a program code to be downloaded.

A further aspect relates to a system for providing a volume model. The system is adapted to execute the method as described herein.

According to example embodiments, the system includes a first computer and a second computer, which are connected to each other via a data communications network such as the Internet. The first computer is adapted to generate the volume model based on the configuration parameters. The second computer is adapted to plausibilize the installation of the object in a technical system with the aid of the volume model.

According to example embodiments, the first computer is adapted to carry out the following: receiving configuration parameters for the object, the configuration parameters indicating the components which make up the object and/or the type of the respective component; generating a construction model for the object from component construction models of the components based on the configuration parameters, a component construction model for each component being stored in a data collection, and a component construction model defining at least one outer surface of the component; generating the volume model for the object from the component volume models of the components, the component volume models being superimposed onto one another, and the outer surfaces of component volume models that are included in an interior space of another component volume model or that abut the outer surfaces of another component volume model are removed.

According to example embodiments, the second computer is adapted to carry out the following: generating the configuration parameters and transmitting the configuration parameters to the first computer, and/or receiving the volume model from the first computer.

According to example embodiments, the system is adapted to plausibilize a construction model of a technical system.

According to example embodiments, the second computer is furthermore adapted to carry out the following: embedding the volume model in a construction model of a technical system that includes the object; and a collision check of the volume model with other construction models of the technical system in order to ascertain a correct installation of the object. If the volume model also includes physical parameters, then it is possible that the second computer is adapted to simulate the object with the aid of the volume model in a construction model of the technical system.

It is possible that the features of the present method are also features of the system and vice versa. If technically feasible but not explicitly mentioned, combinations of example embodiments as described herein should also be considered to be example embodiments hereof.

Hereinafter, exemplary embodiments of the present invention are described in greater detail with reference to the appended Figures.

### BRIEF DESCRIPTION OF THE DRAWINGS

FIG. 1 is a schematic cross-sectional view through an object.

FIG. 2 schematically illustrates construction models for components of the object illustrated in FIG. 1.

FIG. 3 schematically illustrates volume models for components of the object illustrated in FIG. 1.

FIG. 4 schematically illustrates a computer system according to an example embodiment of the present invention.

FIG. 5 schematically illustrates a flow diagram for a method according to an example embodiment of the present invention.

FIG. 6 schematically illustrates a volume model for the object illustrated in FIG. 1.

### DETAILED DESCRIPTION

The reference numerals used in the Figures and their meaning are summarized in the list of reference numerals. Generally, identical or similar parts have been provided with the same reference numerals.

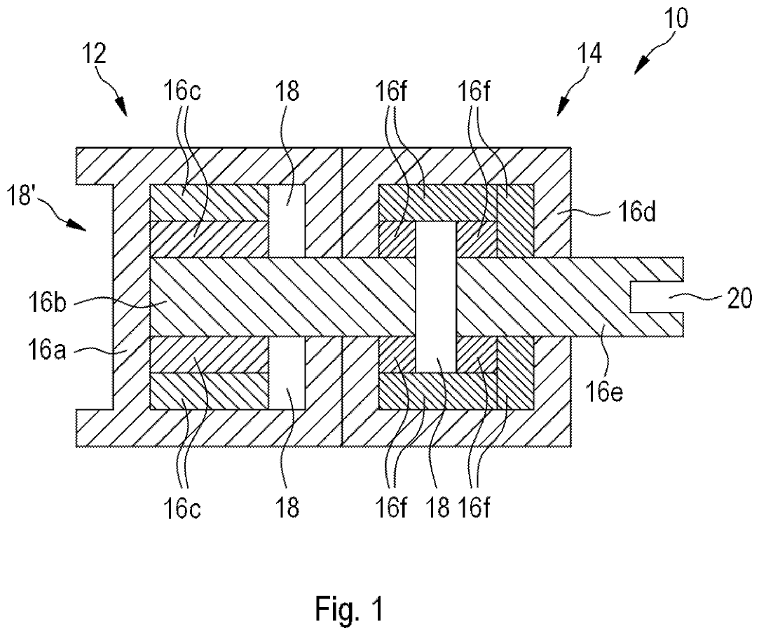

FIG. 1 schematically illustrates an object 10, such as a geared motor which includes an electric motor 12 and a gear unit 14. Object 10 is composed of multiple components 16, such as a motor housing 16a, a motor shaft 16b, electrical components of motor 16c, a gear unit housing 16d, a gear shaft 16e, and further gear components 16f, such as gear wheels, as well as bearings.

It should be understood that the statements made above and below also apply to other objects. In particular, it is possible that the method described herein is used for all kinds of mechanical and/or electromechanical objects.

Object 10 and/or components 16 thereof have cavities 18 and/or depressions 18′, which are either completely enclosed or connected to an environment of object 10.

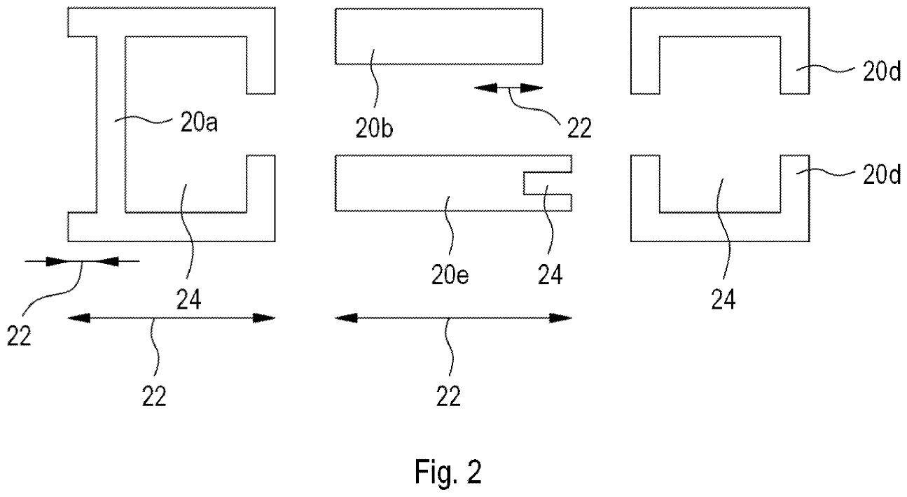

FIG. 2 schematically illustrates component construction models 20 for certain components 16 of object 10, such as for gear unit housing 20a, motor shaft 20b, gear shaft 20e and gear unit housing 20d. It should be understood that all components 16 of object 10 have such component construction models 20. Component construction models 20 as basic construction models include configuration parameters 22 with the aid of which concrete component construction models 20 for components 16 are calculated. Parameters 22, which pertain to lengths of protrusions and housings are illustrated by way of example. Additional possible configuration parameters 22 are mentioned above. Component construction models 20 of components 16 are interconnected to form a construction model 44 for object 10 from which object 10 is produced.

Component construction models 20 have cavities 24 in the interior space in which further components 16 are situated, for example. Because of openings to the outside, it is difficult to distinguish where the interior space of a component 16 begins and/or which components of the interior space are allocated or not allocated to a cavity 24.

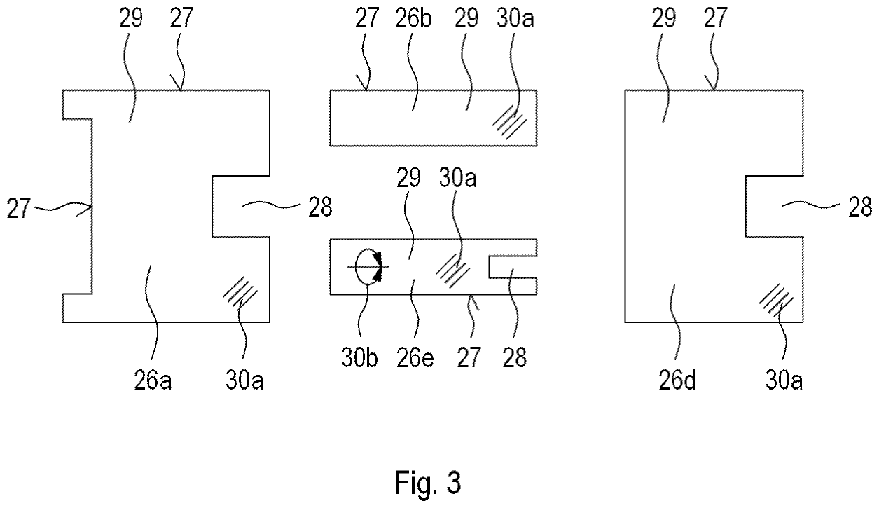

FIG. 3 schematically illustrates component volume models 26 for certain components 16 of object 10, such as for gear unit housing 26a, motor shaft 26b, gear shaft 26e and gear unit housing 26d. Component volume models 26 represent the outer shape of respective component 16, and cavities 24 from component construction models 20 are partially filled. However, component volume models 26 have desired depressions 28, which provide information about the outer shape of object 10.

Component construction models 20 and, optionally, component volume models 26 are created using a CAD software, for instance, and stored in corresponding CAD data files. It is also possible to produce some or all component volume models 26 from component construction models 20. In the process, an interior space of component construction model 20 is filled to form a component 16 in order to obtain component volume model 26 for component 16. The interior space of a component 16 is defined in the respective component construction model 20 and/or is calculated for this purpose. ‘Filling’ means that surfaces situated in the interior space of component 16 are removed and/or outer surfaces are added that restrict the interior space but do not have any outer surfaces in component construction model 20.

For example, models 20, 26 are based on wire frames and/or are defined via their corner points and edges. As illustrated in FIG. 3, component volume models 26 are composed of outer surfaces 27 which completely enclose an interior space 29 of component volume model 26.

A design engineer of respective component 16 of object 10 generates component construction models 20 with the aid of the CAD software and/or adapts them. A component volume model 26 for a component construction model 20 of a component 16 is adapted only if there is a change in the outer shape of component 16. Changes inside and/or in the interior space of the component need not have an effect on component volume model 26. As already mentioned, it is possible that a component volume model 26 is also calculated based on a component construction model 20.

In addition, FIG. 3 illustrates that physical parameters 30 are allocated to each component volume model 26. Physical parameters 30, for instance, include material parameters 30a such as a material type, a thermal conductivity and a weight. Physical parameters 30, for instance, also include mechanical parameters 30b such as an expandability about an axle and/or movability in a space region.

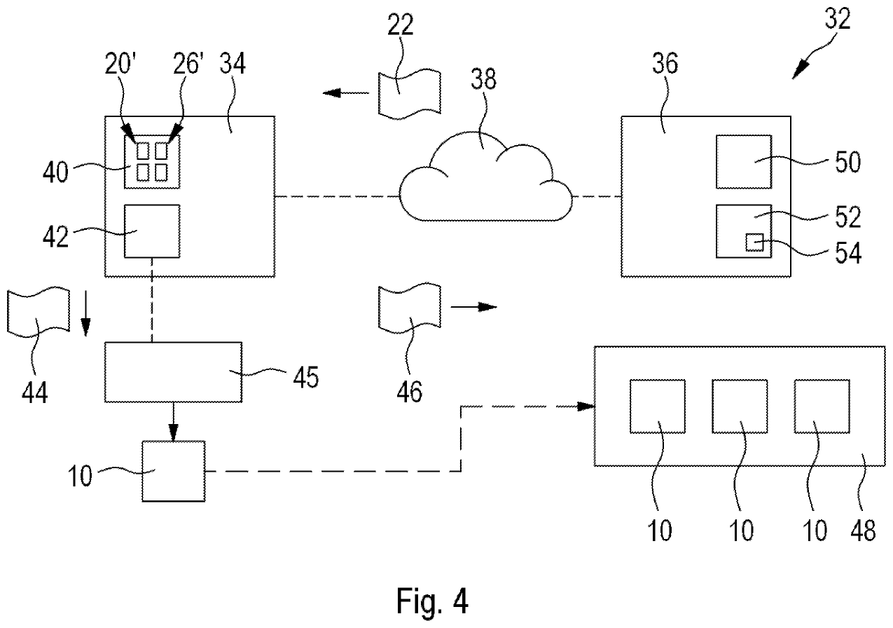

FIG. 4 illustrates a system 32 in which component construction models 20 and, optionally, component volume model 26 and/or basic versions thereof are stored. System 32 includes a first computer 34 and a second computer 36, which are connected for a data exchange via Internet 38. It is possible that the two computers 34, 36 are also systems of computers in each case. The functions that are allocated to respective computers 34, 36 may possibly also be carried out by different units of a computer system.

Stored in first computer 34 are basic construction models 20′ and, optionally, basic volume models 26′ of components 16 in a data collection 40, which is a database or a collection of data files stored in a data system, for instance. A software module 42 is stored and executed in first computer 34, which generates from configuration parameters 22 and basic construction models 20′ component construction models 20 of components 16 for an object 10 and generates a construction model 44 for object 10 from component construction models 20 of components 16. It is furthermore possible that software module 42 generates component volume models 26 from some or all of component construction models 20 in a manner similar to that described above. Optionally, software module 42 is also developed to generate component volume models 26 of components 16 for an object 10 from configuration parameters 22 and basic volume models 26′.

Software module 42 generates a volume model 46 for object 10 from component volume models 26.

It is possible that construction model 44 is transmitted to a production system 45, which uses it to produce object 10. This object 10 or a plurality of objects is installed in a technical system 48, for example.

Volume model 46 is used for ascertaining whether object 10, which is to be produced based on configuration parameters 22, for instance, is also able to be installed in system 48 without any problems.

For this purpose, second computer 36 first has a configurator 50, which configuration parameters 22 are obtained. For instance, configurator 50 is a software module which is provided by first computer 34, for example, and is implemented in a browser of second computer 36.

In addition, second computer 36 has a simulator 52, which receives volume model 46 of object 10 following the configuration. Simulator 52, e.g., a software model in second computer 36, inserts volume model 46 into a system construction model 54 of technical system 48, and a behavior of technical system 48 is simulated based on volume model 46 and optional physical parameters 30. In a simple case, a collision check of object 10 with other objects of technical system 48 is performed in order to check whether the available space is sufficient for object 10.

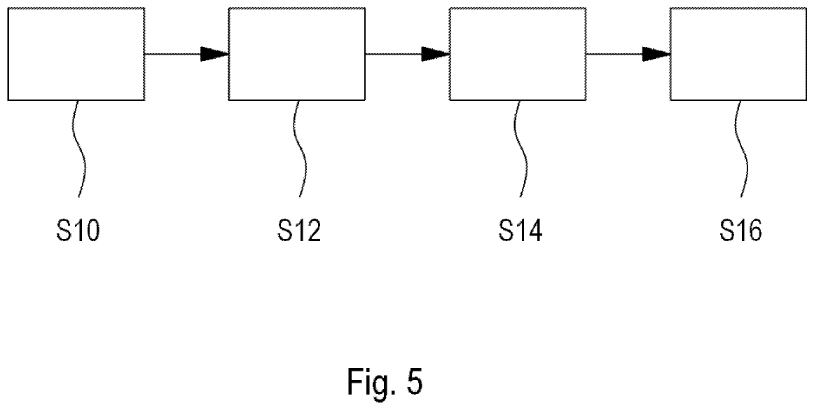

FIG. 5 illustrates a flow diagram for a method able to be carried out by system 32. The method generates volume model 46 for object 10 so that system construction model 54 for technical system 48 is able to be plausibilized and object 10 can be produced after system construction model 54 is plausibilized for technical system 48.

In S10, a configuration for object 10 is obtained with the aid of configurator 50 and selected configuration parameters 22 are transmitted to first computer 34, which receives configuration parameters 22.

In S12, first computer 34 generates volume model 46 for object 10.

In the process, as described above, component construction models 20 are generated based on configuration parameters 22, and using component construction models 20, component volume models 26 are calculated from component construction models 20.

It is also possible that component volume models 26 are generated from basic component volume models 26′ as a function of configuration parameters 22. As described above, different basic component volume models 26′, for instance, are selected for certain components 16 as a function of configuration parameters 22. Basic component volume models 26 are adapted as a function of further configuration parameters 22 in order to configure component volume models 26, for instance by changing lengths, adding and/or omitting parts.

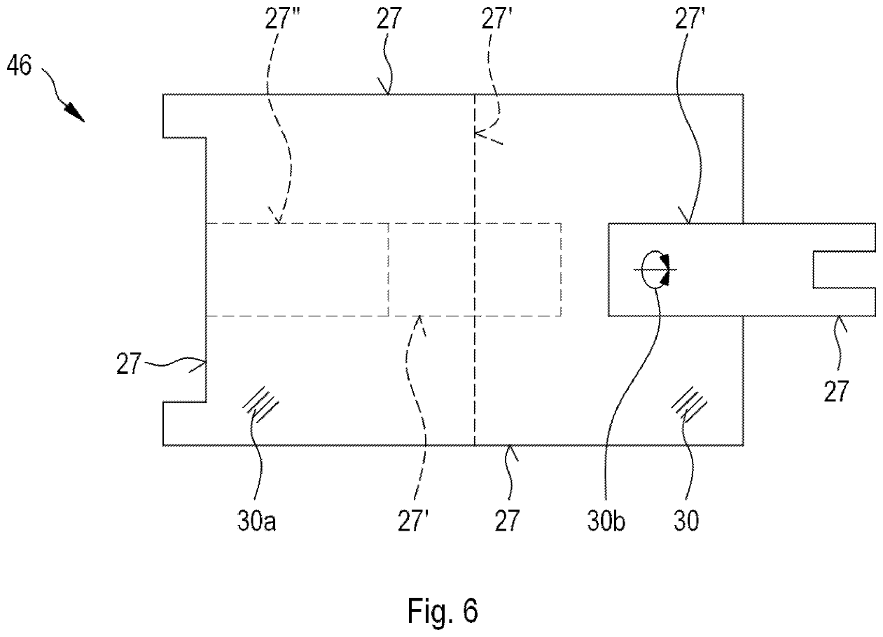

In step S12, first computer 34 generates volume model 46 for object 10 from component volume models 26. This will be described in greater detail with reference to FIG. 6.

The individual component volume models 26 are superimposed onto one another, and their relative offset and orientation are also stored in data collection 40, for instance. Inner surfaces 27″ that are included in an interior space of a component volume model 26 are removed.

It is also possible to retain inner surfaces 27′ which separate regions of volume model 46 to which different physical parameters 30 are allocated. Physical parameters 30 from component volume models 26 are allocated to volume model 46 and if interior regions featuring the same physical parameters 30 such as material parameters 30a overlap or meet, they are merged. In this instance, inner surfaces 27″ are removed and/or regions are created in volume model 46 that have the same physical parameters 30.

When merging and/or superimposing component volume models 26, the component volume models are given a different treatment, for instance, based on rules that are stored in first computer 34. For example, it is distinguished between housing components 16a, 16d to which a volume model 26a, 26d with external surfaces of a housing is allocated; inner components 16c, 16f to which none of these outer surfaces is allocated; and mixed components such as shafts 16b, 16e. For example, physical parameters 30 of housing components 16a, 16d and/or mixed components 16b, 16e overwrite those of inner components 16c, 16f.

It is possible that outer surfaces 27 of component volume models 26 that are situated completely within another component volume model 26 are removed. To be mentioned as an example is the outer surface of a gear wheel which is completely situated within a housing part.

In addition, parts of outer surfaces 27 of component volume models 26 that are situated within another component volume model 26 are removed as well. For instance, outer surface 27 of the part of a shaft that projects into a housing part is removed.

Also removed are outer surfaces 27 of component volume models 26 that abut outer surfaces of another component volume model 26. For instance, inwardly directed outer surface 27 of a bore of a housing part resting against an outer surface 27 of a shaft projecting through the bore is removed.

It is also possible that parts of outer surfaces 27 of component volume models 26 that abut outer surfaces 27 of another component volume model 26 are removed. For example, an outer surface 27 of a shaft projecting through a bore of a housing part that rests against the inwardly directed outer surface of the bore of the housing part is removed.

The removal of outer surfaces 27 of component volume models 26, which initially are inner surfaces 27′, 27″ of volume model 46 aggregated from component volume models 26, leads to merging of many component volume models 26 into a volume model 46 of object 10.

It is possible that volume model 46 is substantially completely filled on the inside and/or therefore corresponds to a solid body. It is furthermore possible that volume model 46 includes only outer surfaces of object 10.

After volume model 46 of object 10 is generated in first computer 34, it is transmitted to second computer 36.

In S14, simulator 52 embeds volume model 46 in system construction model 54 of technical system 48. In a collision check, simulator 52 checks whether object 10 is correctly installable in technical system 48. In this context it is checked, for example, whether volume model 46 overlaps with other construction models of technical system 48. It is also possible that movements of components of technical system 48 are simulated. It is thereby checked whether problems will arise in technical system 48 after real object 10 is installed.

It is also possible that object 10 is simulated in system construction model 54 with the aid of volume model 46 in conjunction with physical parameters 30. In this instance, it is checked, for example, whether a rotatable part is movable in the intended space region, whether a center of gravity and/or weight of object 10 was/were correctly taken into account, and/or whether thermal problems occur.

Depending thereon, it is decided whether object 10 is installable in the configurated form. For example, this is automatically done by second computer 36. The result is reported back to first computer 34 such as via data communications network 38.

In S16, first computer 34 uses configuration parameters 22 to generate a construction model 44 for object 10 provided this was not already done in S12. For each component 16, a basic construction model 20′ is loaded from data collection 40, a component construction model 20 is generated therefrom with the aid of configuration parameters 22, and these component construction models 20 are combined into construction model 44.

Construction model 44 is optionally transmitted to a production system 45, which produces object 10 based on construction model 44.

It should additionally be pointed out that ‘including’ does not exclude other elements or steps and ‘a’ does not exclude a plurality. It should furthermore be mentioned that features or steps that are described with reference to one of the above exemplary embodiments may also be used in combination with other features or steps of other described exemplary embodiments.

### LIST OF REFERENCE NUMERALS

10 object
12 electric motor
14 gear unit
16 component
16a motor housing
16b motor shaft
16c electrical component
16d gear unit housing
16e gear shaft
16f gear unit component
18 cavity
18′ depression
20 component construction model
20a, 20b, 20d, 20e component construction model
20′ basic component construction model
22 configuration parameters
24 cavity
26 component volume model
26a, 26b, 26d, 26e component volume model
26′ basic component volume model
27 outer surface
27′ inner surface
27″ inner surface
28 depression
29 interior space
30 physical parameter
30a material parameter
30b mechanical parameter
32 system
34 first computer
36 second computer
38 data communications network, Internet
40 data collection
42 software module
44 construction model
45 production system
46 volume model
48 technical system
50 configurator
52 simulator
54 system construction model

1-16. (canceled)

17. A method for providing a volume model for a mechanical object that includes multiple components, comprising:
receiving configuration parameters for the object, the configuration parameters indicating the components that make up the object and/or a type of the component;
generating a construction model for the object from component construction models of the components as a function of the configuration parameters, a component construction model for each component being stored in a data collection, and a component construction model defining at least one outer surface of the component; and
generating the volume model for the object from component volume models of the components, the component volume models being superimposed onto one another and outer surfaces of component volume models that are included in an interior space of another component volume model and/or that abut outer surfaces of another component volume model being removed.

18. The method according to claim 17, further comprising generating the component volume models from the component construction models by filling an interior space of the component construction model.

19. The method according to claim 17, further comprising:
generating the component volume models from basic component volume models as a function of the configuration parameters; and
storing in the data collection each basic component volume model together with the component construction model for the component.

20. The method according to claim 17, further comprising:
embedding the volume model in a system construction model of a technical system that includes the object;
performing a collision check of the volume model with other construction models of a technical system; and
ascertaining a correct installation of the object based on the collision check.

21. The method according to claim 17, wherein the volume model is generated in a first computer and is transmitted to a second computer.

22. The method according to claim 17, wherein physical parameters are allocated to each component volume model, and the physical parameters are allocated to the volume model of the object.

23. The method according to claim 22, wherein the physical parameters include material parameters, and the material parameters include a material type, a thermal conductivity, and/or a weight.

24. The method according to claim 22, wherein the physical parameters include mechanical parameters, and the mechanical parameters include a rotatability about an axle and/or movability in a space region.

25. The method according to claim 22, further comprising simulating the object in a system construction model of a technical system based on the physical parameters.

26. The method according to claim 17, wherein a component volume model includes a depression, a cavity, and/or a concave region.

27. The method according to claim 17, further comprising producing the object based on the construction model of the object.

28. The method according to claim 17, wherein the object includes housing components and inner components, a component volume model for outer surfaces of a housing is allocated to the housing components, and no component volume model is allocated to the inner components.

29. The method according to claim 20, wherein the collision check includes determining whether the volume model overlaps with another construction model of the technical system.

30. The method according to claim 17, further comprising transmitting the construction model to a production system.

31. The method according to claim 30, further comprising producing the object by the production system based on the construction model.

32. A non-transitory computer-readable storage medium storing a set of instructions that, when executed by a processor, cause the processor to perform a method for providing a volume model for a mechanical object that includes multiple components that includes:
receiving configuration parameters for the object, the configuration parameters indicating the components that make up the object and/or a type of the component;
generating a construction model for the object from component construction models of the components as a function of the configuration parameters, a component construction model for each component being stored in a data collection, and a component construction model defining at least one outer surface of the component; and
generating the volume model for the object from component volume models of the components, the component volume models being superimposed onto one another and outer surfaces of component volume models that are included in an interior space of another component volume model and/or that abut outer surfaces of another component volume model being removed.

33. A system for providing a volume model, comprising:
a first computer adapted to:
receive configuration parameters for the object, the configuration parameters indicating components of which the object is made and/or a type of the component;
generating a construction model for the object from component construction models of the components based on the configuration parameters, a component construction model for each component being stored in a data collection, and a component construction model defining at least one outer surface of the component; and
generating the volume model for the object from the component volume models of the components, the component volume models being superimposed onto one another and outer surfaces of component volume models that are included in an internal space of another component volume model or that abut the outer surfaces of another component volume model being removed; and
a second computer adapted to receive the volume model from the first computer via a data communications network that connects the second computer to the first computer.

34. The system according to claim 33, wherein the system is adapted to plausibilize a system construction model of a technical system, and the second computer is adapted to:
embedding the volume model in the system construction model of the technical system that includes the object;
perform a collision check of the volume model with other construction models of the technical system; and
ascertain a correct installation of the object based on the collision check.

35. The system according to claim 34, wherein the second computer is adapted to report to the first computer a result of the collision check.

36. The system according to claim 33, further comprising a production system adapted to produce the object based on the construction model.

37. The system according to claim 36, wherein the production system is adapted to receive the construction model transmitted by the first computer and/or the second computer.

38. The system according to claim 37, wherein the first computer and/or the second computer is adapted to transmit the construction model to the production system via the data communications network.
